(19) United States
(12) Patent Application Publication
(10) Pub. No.: US 2016/0104454 A1
(43) Pub. Date: Apr. 14, 2016

(54) ELECTRONIC DEVICE AND METHOD FOR ADJUSTING BRIGHTNESS OF DISPLAY DEVICE OF THE ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-ZHAO HUANG, Wuhan (CN)

(21) Appl. No.: 14/567,677

(22) Filed: Dec. 11, 2014

(30) Foreign Application Priority Data
Oct. 10, 2014 (CN) 201410532419.1

(51) Int. Cl. G09G 5/10; G06F 3/01

(52) U.S. Cl. CPC G09G 5/10; G06F 3/012; G06F 3/013

(57) ABSTRACT

Method of adjusting a brightness of a display device of an electronic device includes obtaining data of a facial feature of a user of the electronic device. The brightness of the display device is adjusted when the brightness of the display device is not suitable for the user, which is determined by comparing the obtained data with preset data of the facial feature.

### CROSS-REFERENCE TO RELATED APPLICATIONS

This application claims priority to Chinese Patent Application No. 201410532419.1 filed on Oct. 10, 2014, the contents of which are incorporated by reference herein.

### FIELD

The subject matter herein generally relates to brightness adjusting technology, and particularly to an electronic device and a method for adjusting a brightness of a display of the electronic device.

### BACKGROUND

Electronic device used with inadequate or excessive lighting may cause eye strain, especially when a display device of the electronic device is too dark or too bright.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including an adjustment system.

FIG. 2 is a block diagram of function modules of the adjustment system included in the electronic device of FIG. 1.

FIG. 3 illustrates a flowchart of one embodiment of a method for adjusting a brightness of a display of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

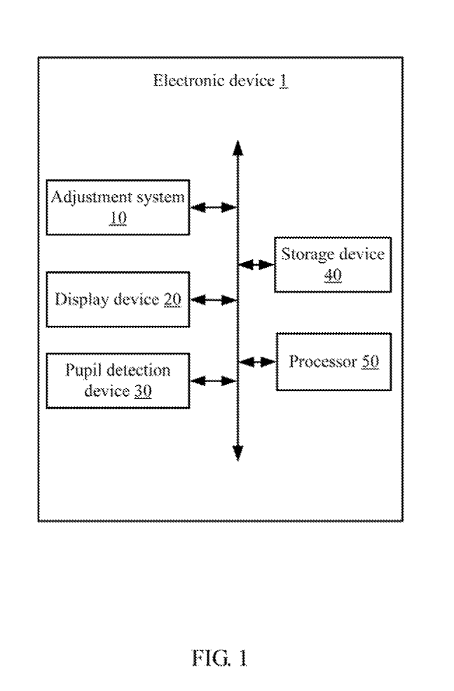

FIG. 1 is a block diagram of one embodiment of an electronic device. Depending on the embodiment, an electronic device 1 includes an adjustment system 10, a display device 20, a pupil detection device 30, a storage device 40, and at least one processor 50. The electronic device 1 may be a smart phone, a personal digital assistant (PDA), a tablet computer, or any other suitable electronic device. FIG. 1 illustrates only one example of the electronic device 1 that may include more or fewer components than illustrated, or have a different configuration of the various components in other embodiments.

In the embodiment, the adjustment system 10 adjusts a brightness of the display device 20 according to data of a facial feature of a user of the electronic device 1. In one embodiment, the data of the facial feature includes a diameter value of a pupil of the user that is obtained from the pupil detection device 30.

In at least one embodiment, when a user uses the electronic device 1, if the brightness of the display device 20 is too bright, the pupil of the user narrows to protect the eyes. That is, the diameter value of the pupil of the user becomes smaller. If the brightness of the display device 20 is too dark, the pupil of the user enlarges to enable the user to see contents displayed on the display device 20. That is, the diameter value of the pupil of the user becomes greater. Thus, the diameter value of the pupil of the user can be used to adjust the brightness of the display device 20 using the adjustment system 10.

The storage device 40 can be an internal storage device, such as a flash memory, a random access memory (RAM) for temporary storage of information, and/or a read-only memory (ROM) for permanent storage of information. The storage device 40 can also be an external storage device, such as an external hard disk, a storage card, or a data storage medium. The at least one processor 50 can be a central processing unit (CPU), a microprocessor, or other data processor chip that performs functions of the electronic device 1.

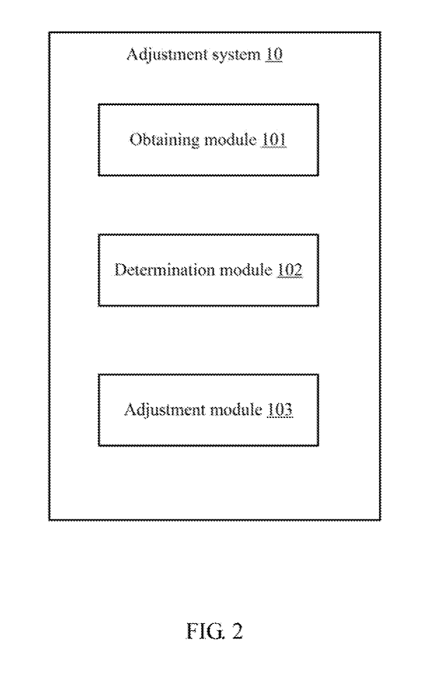

FIG. 2 is a block diagram of function modules of an adjustment system. In at least one embodiment, an adjustment system 10 may include an obtaining module 101, a determination module 102 and an adjustment module 103. The function modules 101, 102, and 103 may include computerized codes in the form of one or more programs, which are stored in the storage device 40, and are executed by the at least one processor 50 to provide functions of the present disclosure. Details will be given in the following paragraphs.

The obtaining module 101 obtains data of the facial feature of the user of the electronic device 1. In at least one embodiment, the data of the facial feature includes the diameter value of the pupil of at least one eye of the user. In the embodiment, the obtaining module 101 obtains the diameter value of the pupil of the user from the pupil detection device 30.

The determination module 102 determines whether the brightness of the display device 20 is suitable for the user by comparing the obtained data with preset data of the facial feature.

In one embodiment, when the diameter value of the pupil of the user is within a preset pupil diameter range, the determination module 102 determines that the brightness of the display device 20 is suitable for the user. For example, if the diameter value of the pupil of the user is 3 millimeters (mm), which is within the preset pupil diameter range (e.g., [2.5 mm, 4 mm]), then the determination module 102 determines that the brightness of the display device 20 is suitable for the user.

When the diameter value of the pupil of the user is out of the preset pupil diameter range, the determination module 102 determines that the brightness of the display device 20 is not suitable for the user.

In another embodiment, the determination module 102 determines that the brightness of the display device 20 is too bright, when the diameter value of the pupil of the user is smaller than a minimum value of the preset pupil diameter range. The determination module 102 determines that the brightness of the display device 20 is too dark, when the diameter value of the pupil of the user is greater than a maximum value of the preset pupil diameter range.

The adjustment module 103 adjusts the brightness of the display device 20 when the brightness of the display device 20 is not suitable for the user.

In one embodiment, the adjustment module 103 turns down the brightness of the display device 20 with a preset brightness value, when the brightness of the display device 20 is determined to be too bright. The adjustment module 103 further turns up the brightness of the display device 20 with the preset brightness value, when the brightness of the display device 20 is determined to be too dark.

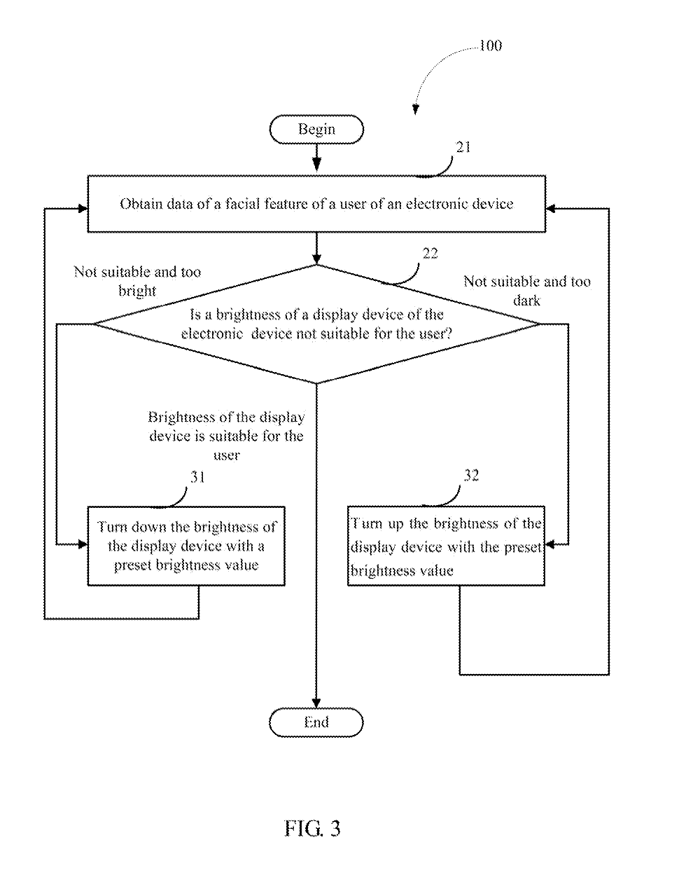

FIG. 3 illustrates a flowchart is presented in accordance with an example embodiment. The example method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 2 represents one or more processes, methods or subroutines, carried out in the exemplary method 100. Furthermore, the illustrated order of blocks is by example only and the order of the blocks can be changed according to the present disclosure. The exemplary method 100 can begin at block 21. Depending on the embodiment, additional steps can be added, others removed, and the ordering of the steps can be changed.

At block 21, an obtaining module obtains data of a facial feature of a user of an electronic device. In at least one embodiment, the data of the facial feature includes a diameter value of a pupil of at least one eye of the user. In the embodiment, the obtaining module obtains the diameter value of the pupil of the user from a pupil detection device.

At block 22, a determination module determines whether a brightness of a display device of the electronic device is not suitable for the user, by comparing the obtained data with preset data of the facial feature. If the brightness of the display device is suitable for the user, the process ends. If the brightness of the display device is not suitable for the user, and the brightness of the display device is determined to be too bright, the process goes to block 31. If the brightness of the display device is not suitable for the user, and the brightness of the display device is determined to be too dark, the process goes to block 32.

In one embodiment, the determination module determines that the brightness of the display device is suitable for the user, when the diameter value of the pupil of the user is within a preset pupil diameter range. For example, if the diameter value of the pupil of the user is 3 millimeters (mm), which is within the preset pupil diameter range (e.g., [2.5 mm, 4 mm]), the determination module determines that the brightness of the display device is suitable for the user, then the process ends.

In one embodiment, the determination module determines that the brightness of the display device is not suitable for the user, and the brightness of the display device is determined to be too bright when the diameter value of the pupil of the user is smaller than a minimum value of the preset pupil diameter range. The determination module determines that the brightness of the display device is not suitable for the user, and the brightness of the display device is determined to be too dark when the diameter value of the pupil of the user is greater than a maximum value of the preset pupil diameter range.

At block 31, an adjustment module turns down the brightness of the display device with a preset brightness value. After the brightness of the display device is turned down with the preset brightness value, the process goes back to block 21.

At block 32, the adjustment module turns up the brightness of the display device with the preset brightness value. After the brightness of the display device is turned up with the preset brightness value, the process goes back to block 21.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for adjusting a brightness of a display device of an electronic device, the method comprising:
obtaining data of a facial feature of a user of the electronic device;
determining whether the brightness of the display device is not suitable for the user by comparing the obtained data with preset data of the facial feature; and
adjusting the brightness of the display device when the brightness of the display device is not suitable for the user.

2. The method according to claim 1, wherein the obtained data comprises a diameter value of a pupil of the user.

3. The method according to claim 2, wherein the obtained data is obtained from a pupil detection device of the electronic device.

4. The method according to claim 2, wherein the brightness of the display device is determined to be not suitable for the user when the diameter value of the pupil of the user is out of a preset pupil diameter range.

5. The method according to claim 4, wherein the brightness of the display device is adjusted by:
turning down the brightness of the display device with a preset brightness value when the diameter value of the pupil of the user is smaller than a minimum value of the preset pupil diameter range; or
turning up the brightness of the display device with the preset brightness value when the diameter value of the pupil of the user is greater than a maximum value of the preset pupil diameter range.

6. An electronic device, comprising:
a display device;
at least one processor; and
a storage device that stores one or more programs, when executed by the at least one processor, cause the at least one processor to:
obtain data of a facial feature of a user of the electronic device;
determine whether a brightness of the display device is not suitable for the user by comparing the obtained data with preset data of the facial feature; and
adjust the brightness of the display device when the brightness of the display device is not suitable for the user.

7. The electronic device according to claim 5, wherein the obtained data comprises a diameter value of a pupil of the user.

8. The electronic device according to claim 7, wherein the obtained data is obtained from a pupil detection device of the electronic device.

9. The electronic device according to claim 7, wherein the brightness of the display device is determined to be not suitable for the user when the diameter value of the pupil of the user is out of a preset pupil diameter range.

10. The electronic device according to claim 9, wherein the brightness of the display device is adjusted by:
turning down the brightness of the display device with a preset brightness value when the diameter value of the pupil of the user is smaller than a minimum value of the preset pupil diameter range; or
turning up the brightness of the display device with the preset brightness value when the diameter value of the pupil of the user is greater than a maximum value of the preset pupil diameter range.

11. A non-transitory storage medium having stored thereon instructions that, when executed by a processor of an electronic device, causes the processor to perform a method for adjusting a brightness of a display device of the electronic device, wherein the method comprises:
obtaining data of a facial feature of a user of the electronic device;
determining whether the brightness of the display device is not suitable for the user by comparing the obtained data with preset data of the facial feature; and
adjusting the brightness of the display device when the brightness of the display device is not suitable for the user.

12. The non-transitory storage medium according to claim 11, wherein the obtained data comprises a diameter value of a pupil of the user.

13. The non-transitory storage medium according to claim 12, wherein the obtained data is obtained from a pupil detection device of the electronic device.

14. The non-transitory storage medium according to claim 12, wherein the brightness of the display device is determined to be not suitable for the user when the diameter value of the pupil of the user is out of a preset pupil diameter range.

15. The non-transitory storage medium according to claim 14, wherein the brightness of the display device is adjusted by:
turning down the brightness of the display device with a preset brightness value when the diameter value of the pupil of the user is smaller than a minimum value of the preset pupil diameter range; or
turning up the brightness of the display device with the preset brightness value when the diameter value of the pupil of the user is greater than a maximum value of the preset pupil diameter range.
